(19) United States
(12) Patent Application Publication
(10) Pub. No.: US 2021/0170684 A1
(43) Pub. Date: Jun. 10, 2021

(54) MANUFACTURING APPARATUS

(71) Applicant: FUJI XEROX CO., LTD., Tokyo (JP)

(72) Inventor: Nobuhiro KATSUTA, Kanagawa (JP)

(73) Assignee: FUJI XEROX CO., LTD., Tokyo (JP)

(21) Appl. No.: 16/835,338

(22) Filed: Mar. 31, 2020

(30) Foreign Application Priority Data
Dec. 6, 2019 (JP) 2019-221536

(51) Int. Cl. B29C 64/218; B33Y 30/00

(52) U.S. Cl. CPC B29C 64/218; B33Y 30/00

(57) ABSTRACT

A manufacturing apparatus includes a delivery unit that delivers at least one linear manufacturing material containing resin, and a pressing unit including an irregularity portion that presses the manufacturing material delivered from the delivery unit, against a target object.

### CROSS-REFERENCE TO RELATED APPLICATIONS

This application is based on and claims priority under 35 USC 119 from Japanese Patent Application No. 2019-221536 filed Dec. 6, 2019.

### BACKGROUND

### 1. Technical Field

The present disclosure relates to a manufacturing apparatus that delivers a manufacturing material.

### 2. Related Art

Examples of a manufacturing apparatus includes a 3D printer as disclosed in JP-T-2016-531020.

In the 3D printer, a void-free reinforced filament is fed to a conduit nozzle. The reinforced filament includes a continuous or semi-continuous core and a matrix material surrounding the core. The reinforced filament is heated to a temperature higher than the melting temperature of the matrix material and lower than the melting temperature of the core before the filament is applied from the conduit nozzle.

US-A-2017-0274585 discloses a manufacturing apparatus using a filament.

The manufacturing apparatus deposits a first composite filament on a build surface. The softened first composite filament retains an ability to be shaped. Then, the first composite filament is flattened.

### SUMMARY

Aspects of non-limiting embodiments of the present disclosure relate to providing a manufacturing apparatus capable of improving adhesion between manufacturing materials as compared with a case in which a pressing unit having a flat surface presses manufacturing materials to stack the manufacturing materials.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a manufacturing apparatus including a delivery unit that delivers at least one linear manufacturing material containing resin, and a pressing unit including an irregularity portion that presses the manufacturing material delivered from the delivery unit, against a target object.

### BRIEF DESCRIPTION OF THE DRAWINGS

Exemplary embodiment(s) of the present disclosure will be described in detail based on the following figures, wherein:

FIG. 1 is a side view illustrating a part of a manufacturing apparatus according to a first exemplary embodiment;

FIG. 2 is a perspective view illustrating a part of the manufacturing apparatus according to the first exemplary embodiment as viewed from below;

FIG. 3 is a front view illustrating a delivery unit of the manufacturing apparatus according to the first exemplary embodiment as viewed from a downstream position in a moving direction of a manufacturing material;

FIG. 4 is a cross-sectional view illustrating a state in which the manufacturing materials are placed on a table of the manufacturing apparatus according to the first exemplary embodiment;

FIG. 5 is a diagram illustrating an example of a configuration for adjusting a height of a pressing unit of the manufacturing apparatus according to the first exemplary embodiment;

FIG. 6 is a diagram illustrating the pressing unit of the manufacturing apparatus according to the first exemplary embodiment;

FIG. 7 is a diagram illustrating a dimension of each part of the pressing unit of the manufacturing apparatus according to the first exemplary embodiment;

FIG. 8 is a diagram illustrating a state in which the manufacturing material is pressed by the pressing unit of the manufacturing apparatus according to the first exemplary embodiment;

FIG. 9 is a diagram following FIG. 8;

FIG. 10 is a diagram illustrating a state in which the manufacturing material is applied in the manufacturing apparatus according to the first exemplary embodiment;

FIG. 11 is a diagram illustrating a state in which the applied manufacturing material is made thinner than the applied manufacturing material in FIG. 10;

FIG. 12 is a cross-sectional view illustrating an aspect ratio of a pressed manufacturing material;

FIG. 13 is a block diagram illustrating functions and a configuration of the manufacturing apparatus according to the first exemplary embodiment;

FIG. 14 is a diagram illustrating a pressing unit of a comparative example;

FIG. 15 is a diagram illustrating results of comparative experiments;

FIG. 16 is a side view illustrating a pressing unit according to a second exemplary embodiment;

FIG. 17 is a side view illustrating a pressing unit according to a third exemplary embodiment; and

FIG. 18 is a side view illustrating a pressing unit according to a fourth exemplary embodiment.

### DETAILED DESCRIPTION

### First Exemplary Embodiment

An example of a manufacturing apparatus 10 according to the first exemplary embodiment will be described with reference to the drawings. An upward direction will be denoted by the sign “UH” and a downward direction will be denoted by the sign “DH” in the drawings.

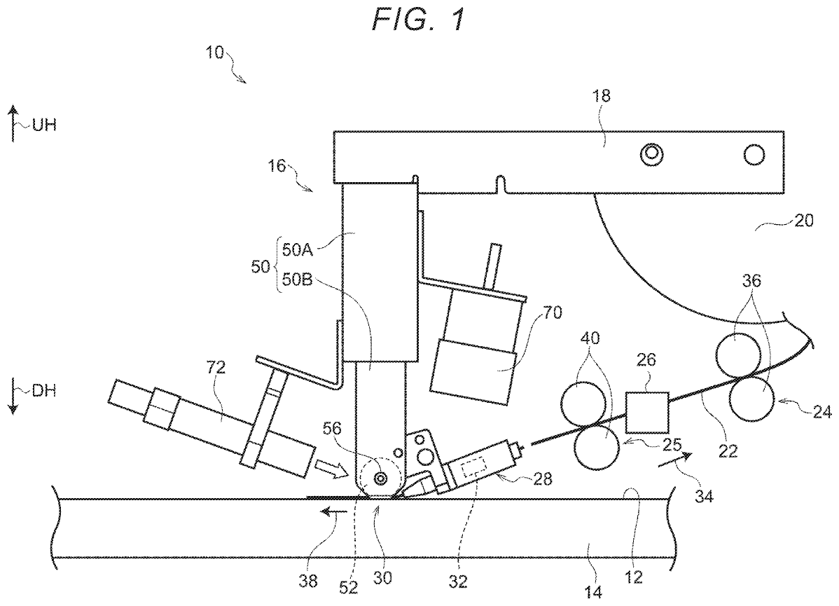

FIG. 1 is a diagram illustrating the manufacturing apparatus 10 according to the present exemplary embodiment. The manufacturing apparatus 10 manufactures a three-dimensional object based on shape data.

The manufacturing apparatus 10 includes a table 14 having a manufacturing surface 12 on which the three-dimensional object is to be manufactured, and a supply device 16 that supplies manufacturing materials to the table 14.

The supply device 16 includes four reels 20 (it is noted that only one reel is illustrated in FIG. 1) that are rotatably supported by a frame 18, upstream transport units 24 that respectively transport linear manufacturing materials 22 delivered from the reels 20, cutting units 26 that respectively cut the manufacturing materials 22 transported by the upstream transport units 24, and downstream transport units 25 that respectively transport the manufacturing materials 22 from the cutting units 26. The supply device 16 further includes a delivery unit 28 that delivers the manufacturing materials 22 from the downstream transport units 25 and a shape adjustment unit 30 that presses the manufacturing materials 22 delivered by the delivery unit 28 against a target object so as to adjust shapes of the manufacturing materials. The delivery unit 28 includes first upstream heating units 32 that heat the manufacturing materials 22 passing through the first upstream heating units 32.

### Table

The table 14 is supported by, for example, a drive table (not illustrated). The drive table drives the table 14 in X-Y directions along a horizontal surface, in height directions (in the upward direction UH and the downward direction DH), and in a rotation direction based on the shape data of the three-dimensional object. With this configuration, the three-dimensional object is manufactured on the manufacturing surface 12 with the manufacturing materials 22 delivered from the supply device 16 to the table 14.

The present exemplary embodiment will describe a case in which the three-dimensional object is manufactured by driving the table 14 based on the shape data. It is noted that the present disclosure is not limited to this case. For example, the supply device 16 may be driven by a manipulator based on the shape data to manufacture the three-dimensional object.

### Reel

The manufacturing material 22 by held in the reel 20 with the manufacturing material 22 being wound on the reel 20. The wound manufacturing material 22 can be drawn out.

### Manufacturing Material

As illustrated in FIG. 4 (see also FIG. 8), the manufacturing material 22 includes plural continuous fibers 22A and a resin 22B with which the continuous fibers 22A are impregnated. Examples of the continuous fibers 22A includes a carbon fiber. The resin 22B with which the manufacturing material 22 is impregnated is made of thermoplastic resin. Accordingly, the manufacturing material 22 can be softened and deformed when heated, and maintains its shape after cured at room temperature.

The continuous fibers 22A are used in the present exemplary embodiment. It is noted that the present disclosure is not limited to the continuous fibers 22A. Alternatively, a short fiber or a glass fiber may be used.

### Transport Unit

As illustrated in FIG. 1, the upstream transport unit 24 includes a pair of upstream rollers 36 provided upstream 34 of the cutting unit 26 in a moving direction of the manufacturing material 22. The downstream transport unit 25 includes a pair of downstream rollers 40 provided downstream 38 of the cutting unit 26 in the moving direction.

The manufacturing material 22 is sandwiched between the upstream rollers 36. When the upstream rollers 36 are driven to rotate, the manufacturing material 22 from the reel 20 is delivered to the cutting unit 26. The manufacturing material 22 delivered from the cutting unit 26 is sandwiched between the downstream rollers 40. When the downstream rollers 40 are driven to rotate, the manufacturing material 22 from the cutting unit 26 is delivered to the delivery unit 28.

### Cutting Unit

Upon receipt of a cutting signal from a control device (not illustrated), the cutting unit 26 cuts the manufacturing material 22 between the upstream transport unit 24 and the downstream transport unit 25. Accordingly, the manufacturing material 22 is cut to a length required in manufacturing.

The downstream transport unit 25 delivers the cut manufacturing material 22 to the delivery unit 28. Accordingly, the three-dimensional object is manufactured using the cut manufacturing material 22 to a specified length.

The present exemplary embodiment will describe an example in which the supply device 16 includes the cutting unit 26. It is noted that the present disclosure is not limited to this configuration. The supply device 16 may not include the cutting unit 26.

### Delivery Unit

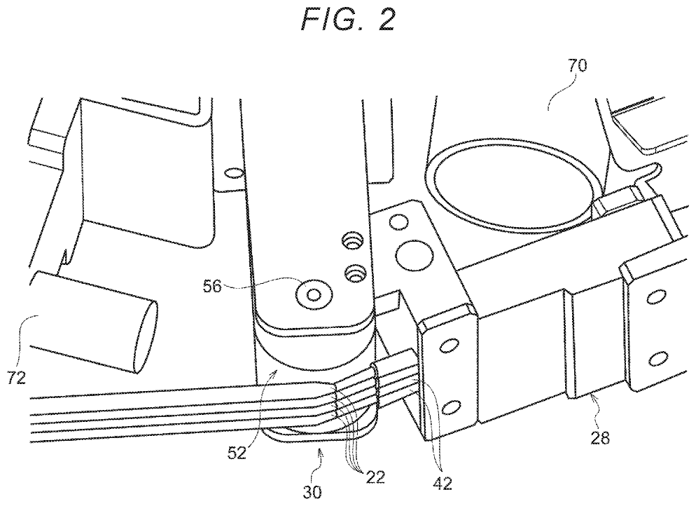

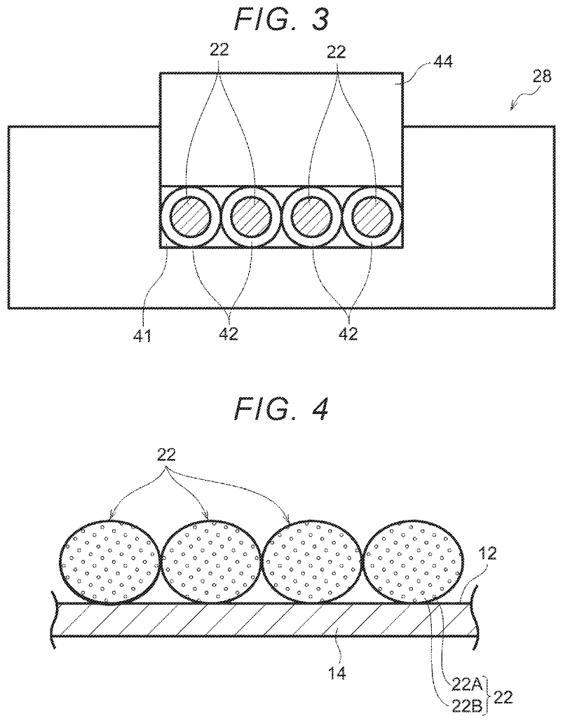

As illustrated in FIG. 2, the delivery unit 28 is formed into a rectangular block shape. As illustrated in FIG. 3, the delivery unit 28 includes a rectangular recess portion 41 extending in a length direction. Four cylindrical bodies 42 are arranged side by side along a bottom surface and accommodated in the rectangular recess portion 41. A block 44 is inserted into the rectangular recess portion 41 so as to prevent the cylindrical bodies 42 from being detached.

The first upstream heating unit 32 (not illustrated) is provided on an outer peripheral portion of each cylindrical body 42. The first upstream heating unit 32 is implemented by, for example, a heater including an electric heating wire. Each heater heats a corresponding cylindrical body 42 based on a heating signal from the control device, so as to heat, from the outer peripheral portion, the manufacturing material 22 passing through the corresponding cylindrical body 42 to a specified temperature.

Accordingly, as illustrated in FIG. 4, the delivery unit 28 applies the four manufacturing materials 22 onto the manufacturing surface 12 of the table 14 such that the four manufacturing materials 22 are arranged side by side and adjacent to each other. The manufacturing surface 12 of the table 14 is an example of the target object. Here, examples of the target object include a manufacturing material 22 that has been applied onto the table 14 as a lower layer as well as the manufacturing surface 12 of the table 14.

### Shape Adjustment Unit

As illustrated in FIG. 1, the shape adjustment unit 30 includes an extending unit 50 extending downwards from the frame 18, and a pressing unit 52 replaceably attached to a lower end portion of the extending unit 50. The extending unit 50 includes an extending unit body 50A fixed to the frame 18, and an operation shaft 50B extending from the extending unit body 50A. The extending unit body 50A adjusts an extension amount of the operation shaft 50B based on an operation signal from the control device (not illustrated).

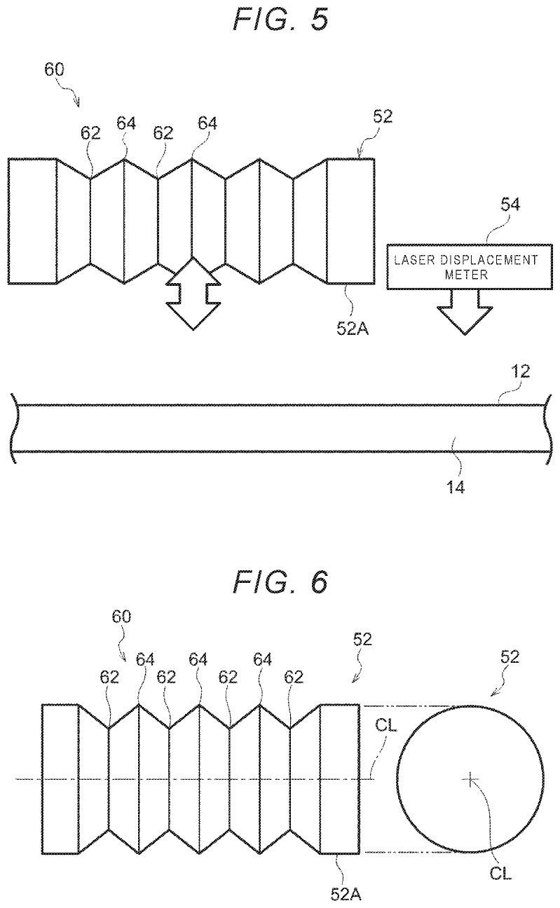

As illustrated in FIG. 5, for example, a laser displacement meter 54 is provided at a tip end of the extending unit 50. The laser displacement meter 54 measures a distance from a lower portion of an outer peripheral surface 52A of the pressing unit 52 to the target object. The control device adjusts the extension amount of the operation shaft 50B such that the distance measured by the laser displacement meter 54 becomes a target distance. The shape adjustment unit 30 adjusts and controls a shape of the manufacturing material 22 in a thickness direction by pressing the pressing unit 52 against the manufacturing material 22.

Here, in place of the method described above, the following method may be used as a method for setting the distance from the outer peripheral surface 52A of the pressing unit 52 to, for example, the manufacturing surface 12 of the table 14. That is, the method calculates the distance based on the extension amount of the operation shaft 50B, using an initial value when the pressing unit 52 is pressed against the manufacturing surface 12 as a reference.

### Pressing Unit

As illustrated in FIG. 6, the pressing unit 52 is formed in a columnar shape. As illustrated in FIG. 1, the pressing unit 52 is rotatably supported by the operation shaft 50B via a shaft portion 56 that passes through a center CL. An extending direction of the shaft portion 56 intersects the moving direction of the manufacturing material 22 moved by the transport units 24 and 25. The pressing unit 52 rotates with the outer peripheral surface 52A being in contact with the manufacturing material 22 that is supplied and applied onto the table 14, so as to move in a length direction of the manufacturing material 22.

As illustrated in FIG. 6, the outer peripheral surface 52A of the pressing unit 52 is formed with an irregularity portion 60 that presses the manufacturing materials 22 delivered from the delivery unit 28 against the target object. It is noted that the irregularity portion 60 is exaggerated in the drawings.

The irregularity portion 60 includes four recess portions 62 arranged in a length direction of the pressing unit 52. Each recess portion 62 is formed into a V shape and extends in a circumferential direction.

The recess portions 62 are arranged in the length direction such that the recess portion 62 and a protruding portion 64 having a triangle cross section are alternately formed on the outer peripheral surface 52A of the pressing unit 52. The recess portions 62 and the protruding portions 64 constitute the irregularity portion 60 of the pressing unit 52.

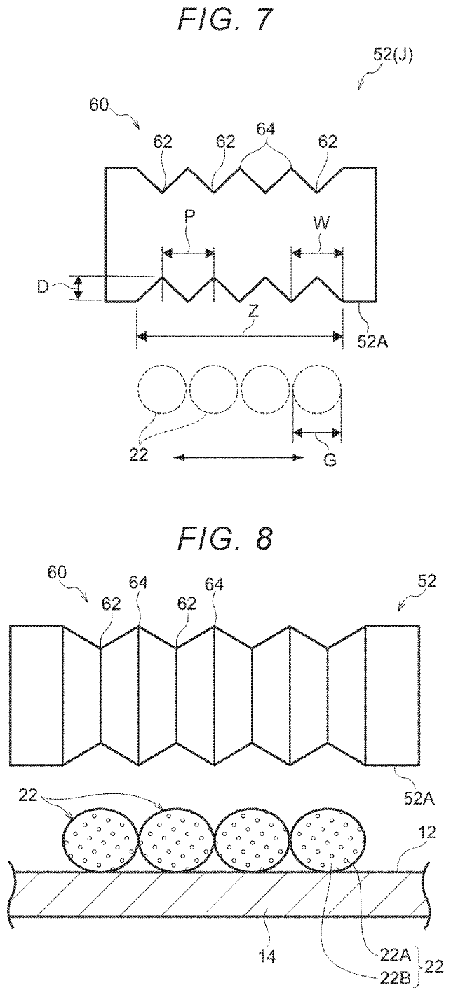

As illustrated in FIG. 7, a width W of each recess portion 62 constituting the irregularity portion 60 in a direction intersecting the manufacturing material 22, that is, the width W of each recess portion 62 in the length direction of the pressing unit 52 is larger than an outer dimension G of the manufacturing material 22 (for example, G<W≤2G). A depth D of the recess portion 62 is smaller than the outer dimension G of the manufacturing material 22 (for example, 0.4G<D<G).

Accordingly, variation in pressure for filaments can be reduced when the irregularity portion 60 presses the manufacturing material 22.

Plural recess portions 62 that constitute the irregularity portion 60 are provided in an arrangement direction in which the manufacturing materials 22 are arranged. A pitch P from a center of one of two adjacent recess portions 62 to a center of the other adjacent recess portion 62 is equal to or less than twice the outer dimension G of the manufacturing material 22 (for example, G<P≤2G).

Specifically, in the present exemplary embodiment, the outer dimension G of the manufacturing material 22 is 0.5 mm, and the width W of the recess portion 62 is 1.0 mm which is larger than the outer dimension G of the manufacturing material 22. The depth D of the recess portion 62 is 0.4 mm which is smaller than the outer dimension G of the manufacturing material 22.

The pitch P from the center of one of the two adjacent recess portions 62 to the center of the other adjacent recess portion 62 is 1.0 mm which is equal to or less than twice the outer dimension G of the manufacturing material 22. The entire width Z of the recess portions from an edge of the recess portion 62 on one side to the other edge of the recess portion 62 on the other side is 4.0 mm.

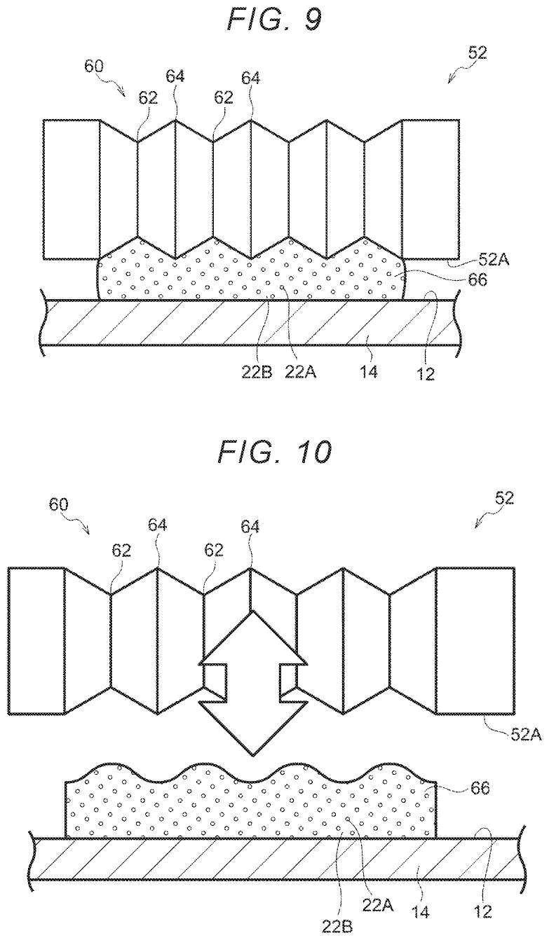

Then, as illustrated in FIGS. 8 and 9, the pressing unit 52 presses, against the target object, the plural manufacturing materials 22 which are arranged side by side and joins adjacent manufacturing materials 22 together, so as to form a pressed manufacturing material 66 in which the plural manufacturing materials 22 are joined together and form irregularities on a surface of the pressed manufacturing material 66.

The present exemplary embodiment describes a case in which the plural manufacturing materials 22 are pressed and joined together, so as to form the pressed manufacturing material 66 in which the plural manufacturing materials 22 are joined together. It is noted that the present disclosure is not limited to this case. For example, the pressed manufacturing material 66 may be formed by pressing one manufacturing material 22.

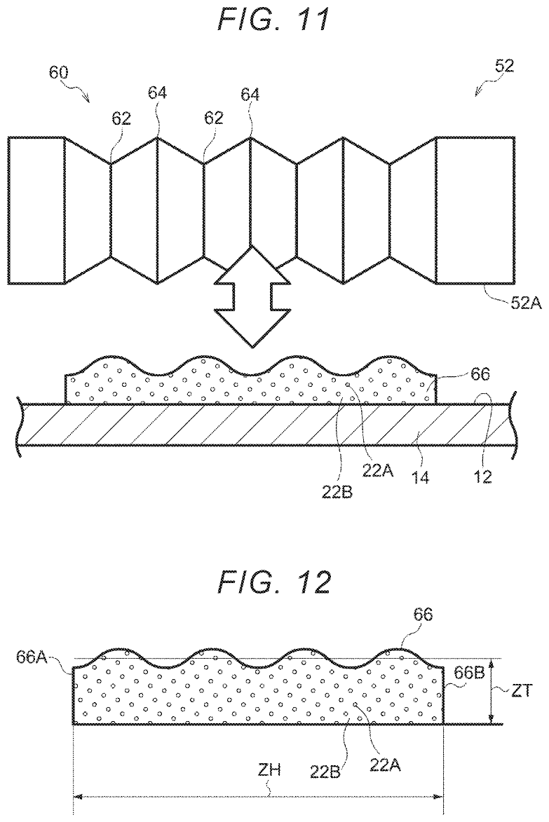

Here, the control device can control an aspect ratio indicating a ratio of a width ZH of the pressed manufacturing material 66 to a thickness ZT of the pressed manufacturing material 66 as illustrated in FIG. 10, FIG. 11 (an example in which a press force from the pressing unit 52 is large), and FIG. 12 by adjusting the extension amount of the operation shaft 50B such that the distance measured by the laser displacement meter 54 (see FIG. 5) becomes the target distance. The aspect ratio of the pressed manufacturing material 66 is 2 or more and 5 or less. It has been found from experimental results that the aspect ratio is preferably 2 or more and 5 or less.

As illustrated in FIG. 12, the width ZH of the pressed manufacturing material 66 is a dimension from one side edge 66A of the pressed manufacturing material 66 to the other side edge 66B of the pressed manufacturing material 66. The thickness ZT of the pressed manufacturing material 66 is a dimension into which a cross-sectional area of the pressed manufacturing material 66 is converted. More specifically, the thickness ZT of the pressed manufacturing material 66 is a value obtained by dividing the cross-sectional area of the pressed manufacturing material 66 by the width ZH.

A method for adjusting the aspect ratio includes, but not limited to, adjusting a shape of the manufacturing materials 22, changing a surface shape of the irregularity portion 60, changing a heating temperature of the irregularity portion 60, and changing a separation distance between the irregularity portion 60 and the target object.

As illustrated in FIG. 1, the supply device 16 includes a second upstream heating unit 70 that heats the manufacturing materials 22 upstream 34 of the pressing unit 52 in the moving direction of the manufacturing materials 22. The second upstream heating unit 70 is a device that blows hot air towards the delivery unit 28. For example, the second upstream heating unit 70 heats manufacturing materials 22 overall by blowing the hot air to the manufacturing materials 22 passing through the rectangular recess portion 41 of the delivery unit 28, so as to aggregate the manufacturing materials 22.

The second upstream heating unit 70 may be a device that heats the manufacturing materials 22 with radiant heat.

The supply device 16 includes a downstream heating unit 72 that is provided downstream 38 of the first upstream heating unit 32 in the moving direction of the manufacturing materials 22. The downstream heating unit 73 heats the manufacturing materials 22.

The downstream heating unit 72 is a device that blows hot air towards the pressing unit 52. The downstream heating unit 72 heats the pressing unit 52 so as to heat the manufacturing materials 22 pressed by the pressing unit 52.

The downstream heating unit 72 may be a device that heats the pressing unit 52 with radiant heat.

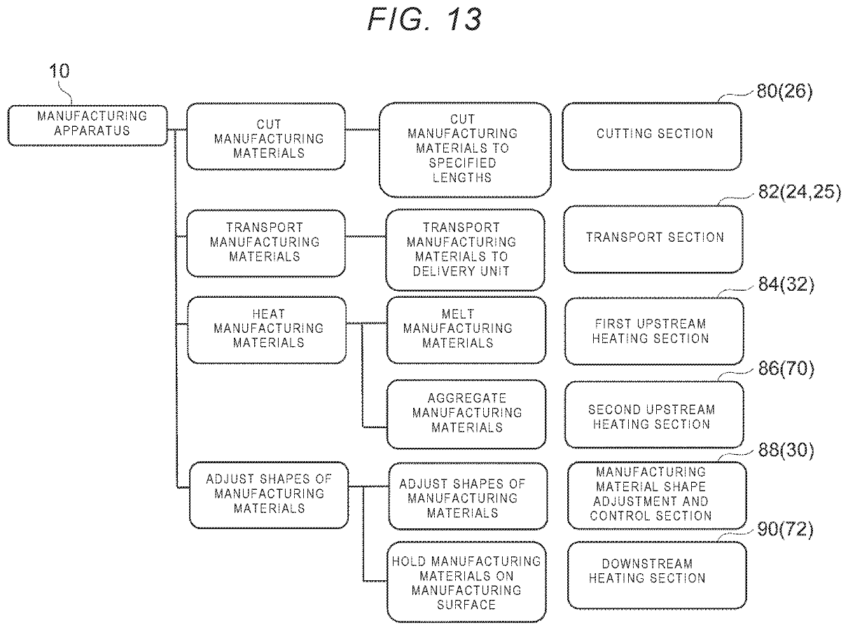

FIG. 13 is a block diagram illustrating functions and a configuration of the manufacturing apparatus 10.

The cutting units 26 are provided in a cutting section 80 that cuts the manufacturing materials 22. The cutting units 26 cut the manufacturing materials 22 passing through the cutting units 26 to a specified length based on the cutting signals from the control device. The transport units 24 and 25 are provided in a transport section 82 that transports the manufacturing materials 22. The transport units 24 and 25 transport the manufacturing materials 22 to the delivery unit 28.

The first upstream heating unit 32 is provided in a first upstream heating section 84 that heats the manufacturing materials 22. The first upstream heating unit 32 heats and melts the manufacturing materials 22. The second upstream heating unit 70 is provided in a second upstream heating section 86 that heats manufacturing materials 22 overall. The second upstream heating unit 70 aggregates the manufacturing materials 22.

The shape adjustment unit 30 provided in a manufacturing material shape adjustment and control section 88 adjusts a shape of the manufacturing materials 22. The downstream heating unit 72 is provided in a downstream heating section 90 that heats the manufacturing materials 22. The downstream heating unit 72 causes the manufacturing surface 12 to hold the manufacturing materials 22.

### Comparative Experiments

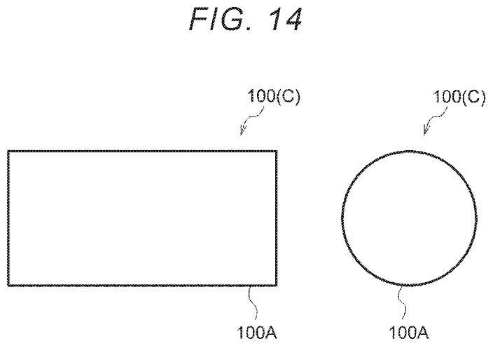

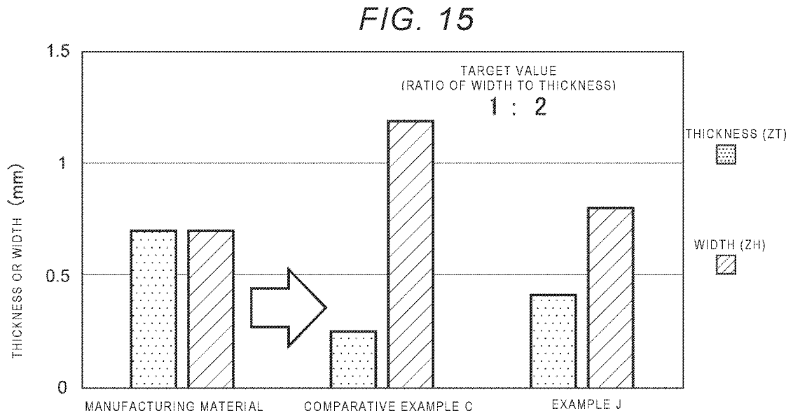

FIGS. 14 and 15 are diagrams illustrating comparative experiments.

The comparative experiments include an example J and a comparative example C. In the example J, the metal pressing unit 52 includes the irregularity portion 60 on the outer peripheral surface 52A as described in the exemplary embodiment described with reference to FIG. 7. In the comparative example C, a metal cylindrical pressing unit 100 has no irregularity portion on an outer peripheral surface 100A as illustrated in FIG. 14.

Parameters such as the width W, the depth D, and the pitch P of the recess portions 62 of the irregularity portion 60 formed in the pressing unit 52 of the example J are the same as those of the pressing unit 52 illustrated in FIG. 7.

The manufacturing material 22 used for manufacturing has a circular cross section. As illustrated in FIG. 15, a thickness and a width of the manufacturing material 22 are about 0.7 mm (an outer dimension of the manufacturing material 22 may be 0.5 mm). The manufacturing material 22 used for manufacturing by the pressing unit 52 of the example J and the manufacturing material 22 used for manufacturing by the pressing unit 100 of the comparative example C have the same bending modulus.

Then, the pressing unit 52 of the example J is mounted on the manufacturing apparatus 10, and a three-dimensional object is manufactured with one manufacturing material 22. Also, the pressing unit 100 of the comparative example C is mounted on the manufacturing apparatus 10, and a three-dimensional object is manufactured using one manufacturing material 22. At this time, a target value is set such that a ratio of the width ZH to the thickness ZT of the pressed manufacturing material 66 is 1:2, and the manufacturing apparatus 10 is controlled using the target value. The width ZH and the thickness ZT of a cross-sectional shape of the pressed manufacturing material 66 after the manufacturing process is measured.

As illustrated in FIG. 15, a different between the width ZH and the thickness ZT of the pressed manufacturing material 66 that is formed using the pressing unit 52 of the example J is smaller than a difference between the width ZH and the thickness ZT of the pressed manufacturing material 66 that is formed using the pressing unit 100 of the comparative example C. Accordingly, experiment result is obtained which shows a ratio of the width ZH to the thickness ZT is approximate to the target value of 1:2.

### Effects

Effects of the present exemplary embodiment having the above configurations will be described.

The manufacturing apparatus 10 according to the present exemplary embodiment includes the pressing unit 52 having the irregularity portion 60 that presses the manufacturing materials 22 delivered from the delivery unit 28 against the target object.

Therefore, as compared with a case in which the manufacturing materials 22 are stacked by being pressed with a pressing unit having a flat surface, adhesion between the manufacturing materials 22 can be improved.

Adhesion between the manufacturing materials 22 and adhesion between the manufacturing materials 22 and the manufacturing surface 12 can be improved in particular in manufacturing a curved shape.

Since two sides of the manufacturing material 22 are regulated by the irregularity portion 60, dimensional accuracy in a width direction of the three-dimensional object can be improved.

The width W of the recess portion 62, which constitutes the irregularity portion 60 of the pressing unit 52, in a direction intersecting the manufacturing material 22 is larger than the outer dimension G of the manufacturing material 22.

Therefore, the manufacturing materials 22 can be easily positioned as compared with a case in which the width W of the recess portion 62 is smaller than the outer dimension G of the manufacturing material 22.

The depth D of the recess portion 62 is smaller than the outer dimension G of the manufacturing material 22.

Therefore, a crushing margin for the manufacturing material 22 can be provided as compared with a case in which the depth D of the recess portion 62 is larger than the outer dimension G of the manufacturing material 22.

The pressing unit 52 presses and join together the plural manufacturing materials 22, which are arranged side by side, so as to form the irregularities on the pressed manufacturing material 66 in which the plural manufacturing materials 22 are joined together.

Therefore, manufacturing efficiency can be improved as compared with a case in which one manufacturing material 22 is pressed to form the pressed manufacturing material 66.

The plural recess portions 62, which constitute the irregularity portion 60, are provided in an arrangement direction in which the manufacturing materials 22 are arranged. The pitch P from the center of one of two adjacent recess portions 62 to the center of the other adjacent recess portion 62 is equal to or less than twice the outer dimension G of the manufacturing material 22.

Therefore, a density of protruding portions formed on the pressed manufacturing material 66 can be prevented from lowering as compared with a case in which the pitch P between adjacent recess portions 62 is larger than twice the outer dimension G of the manufacturing material 22.

The aspect ratio indicating the ratio of the width ZH of the pressed manufacturing material 66 to the thickness ZT of the pressed manufacturing material 66 is 2 or more and 5 or less.

Therefore, the pressed manufacturing material 66 can be prevented from spreading in the width direction as compared with a case in which the aspect ratio of the pressed manufacturing material 66 is larger than 5.

The upstream heating units 32 and 70 that heat the manufacturing materials 22 are provided upstream 34 of the pressing unit 52 in the moving direction of the manufacturing materials 22.

Therefore, irregularities can be easily formed as compared with a case in which the manufacturing materials 22 are heated only from a downstream position.

The pressed manufacturing material 66 can be more easily joined as compared with a case in which the manufacturing material 22 is heated only from an upstream position.

Therefore, the pressed manufacturing material 66 can be more easily adhered as compared with a case in which the downstream heating unit 72 is not provided.

The downstream heating unit 72 heats the pressing unit 52 so as to heat the manufacturing material 22 pressed by the pressing unit 52.

Therefore, irregularities can be easily formed as compared with a case in which the manufacturing material 22 is directly heated downstream of the pressing unit 52.

The present exemplary embodiment describes a case in which the recess portions 62 of the irregularity portion 60 of the pressing unit 52 are formed into a V-shaped groove. It is noted that the recess portions 62 are not limited to this case, but may have the following shapes.

### Second Exemplary Embodiment

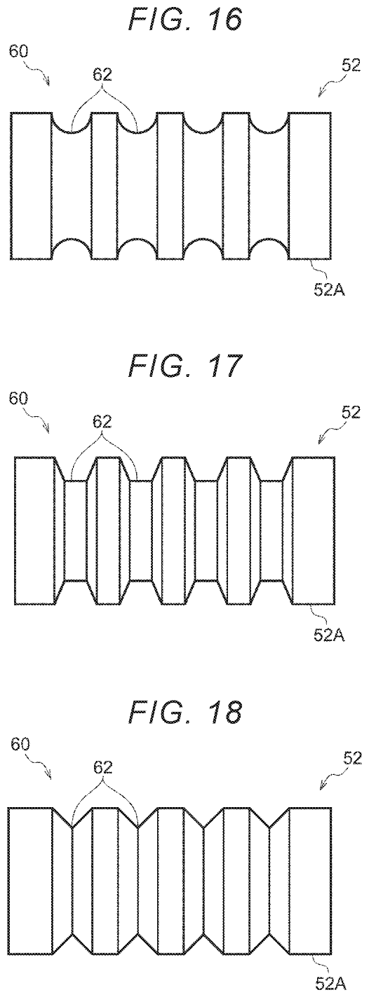

As illustrated in FIG. 16, the recess portions 62 of the irregularity portion 60 of the pressing unit 52 may be formed into a groove having an arc cross section. The second exemplary embodiment provides the same effect as the first exemplary embodiment.

### Third Exemplary Embodiment

As illustrated in FIG. 17, the recess portions 62 of the irregularity portion 60 of the pressing unit 52 may be formed into a groove having a trapezoidal cross section. The third exemplary embodiment provides the same effect as the first exemplary embodiment.

### Fourth Exemplary Embodiment

As illustrated in FIG. 18, the recess portions 62 of the irregularity portion 60 of the pressing unit 52 may be formed into a V-shaped groove, and adjacent recess portions 62 may be separated such that the cylindrical outer peripheral surface 52A remains between the recess portions 62. The fourth exemplary embodiment provides the same effect as the first exemplary embodiment.

The pressing unit 52 has a cylindrical shape in the exemplary embodiments. It is noted that the pressing unit 52 is not limited to the cylindrical shape, but may have a plate shape.

The heating units 32, 70 and 72 may be omitted.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A manufacturing apparatus comprising:
a delivery unit that delivers at least one linear manufacturing material containing resin; and
a pressing unit comprising an irregularity portion that presses the manufacturing material delivered from the delivery unit, against a target object.

2. The manufacturing apparatus according to claim 1, wherein a width of a recess portion constituting the irregularity portion in a direction intersecting the manufacturing material is larger than an outer dimension of the manufacturing material.

3. The manufacturing apparatus according to claim 2, wherein a depth of the recess portion is smaller than the outer dimension of the manufacturing material.

4. The manufacturing apparatus according to claim 1, wherein
the at least one manufacturing material comprises a plurality of manufacturing materials, and
the irregularity portion of the pressing unit presses, against the target object, the plurality of manufacturing materials that are arranged side by side and joins the plurality of manufacturing materials together, so as to form a pressed manufacturing material in which the plurality of manufacturing materials are joined together.

5. The manufacturing apparatus according to claim 4, wherein
a plurality of recess portions that constitute the irregularity portion are provided in an arrangement direction in which the manufacturing materials are arranged, and
a pitch from a center of one of adjacent recess portions to a center of the other of the adjacent recess portions is equal to or less than twice an outer dimension of the manufacturing materials.

6. The manufacturing apparatus according to claim 4, wherein an aspect ratio indicating a ratio of a width of the pressed manufacturing material to a thickness of the pressed manufacturing material is 2 or more and 5 or less.

7. The manufacturing apparatus according to claim 1, further comprising:
an upstream heating unit provided upstream of the pressing unit in a moving direction of the manufacturing material, the upstream heating unit heating the manufacturing material.

8. The manufacturing apparatus according to claim 2, further comprising:
an upstream heating unit provided upstream of the pressing unit in a moving direction of the manufacturing material, the upstream heating unit heating the manufacturing material.

9. The manufacturing apparatus according to claim 3, further comprising:
an upstream heating unit provided upstream of the pressing unit in a moving direction of the manufacturing material, the upstream heating unit heating the manufacturing material.

10. The manufacturing apparatus according to claim 4, further comprising:
an upstream heating unit provided upstream of the pressing unit in a moving direction of the manufacturing materials, the upstream heating unit heating the manufacturing materials.

11. The manufacturing apparatus according to claim 5, further comprising:
an upstream heating unit provided upstream of the pressing unit in a moving direction of the manufacturing materials, the upstream heating unit heating the manufacturing materials.

12. The manufacturing apparatus according to claim 6, further comprising:
an upstream heating unit provided upstream of the pressing unit in a moving direction of the manufacturing materials, the upstream heating unit heating the manufacturing materials.

13. The manufacturing apparatus according to claim 7, further comprising:
a downstream heating unit provided downstream of the upstream heating unit in the moving direction of the manufacturing material, the downstream heating unit heating the manufacturing material.

14. The manufacturing apparatus according to claim 8, further comprising:
a downstream heating unit provided downstream of the upstream heating unit in the moving direction of the manufacturing material, the downstream heating unit heating the manufacturing material.

15. The manufacturing apparatus according to claim 9, further comprising:
a downstream heating unit provided downstream of the upstream heating unit in the moving direction of the manufacturing material, the downstream heating unit heating the manufacturing material.

16. The manufacturing apparatus according to claim 10, further comprising:
a downstream heating unit provided downstream of the upstream heating unit in the moving direction of the manufacturing materials, the downstream heating unit heating the manufacturing materials.

17. The manufacturing apparatus according to claim 11, further comprising:
a downstream heating unit provided downstream of the upstream heating unit in the moving direction of the manufacturing materials, the downstream heating unit heating the manufacturing materials.

18. The manufacturing apparatus according to claim 12, further comprising:
a downstream heating unit provided downstream of the upstream heating unit in the moving direction of the manufacturing materials, the downstream heating unit heating the manufacturing materials.

19. The manufacturing apparatus according to claim 13, wherein the downstream heating unit heats the pressing unit so as to heat the manufacturing material pressed by the pressing unit.

20. A manufacturing apparatus comprising:
delivery means for delivering at least one linear manufacturing material containing resin; and
pressing means comprising irregularity means for pressing the manufacturing material delivered from the delivery means, against a target object.
